(19) United States
(12) Patent Application Publication
(10) Pub. No.: US 2007/0042225 A1
(43) Pub. Date: Feb. 22, 2007

(54) Supported ceramic membranes and electrochemical cells including the same

(76) Inventors: Matthew M. Seabaugh, Columbus, OH (US); Katarzyna Sabolsky, Westerville, OH (US)

Correspondence Address: Porter, Wright, Morris & Arthur LLP;IP DOCKETING, Attn: Charma Murphy, 28th Floor, 41 South High St., Columbus, OH, 43215-6194, US

(21) Appl. No.: 11/261,404

(22) Filed: Oct. 29, 2005

Related U.S. Application Data
(60) Provisional application No. 60/623,694, filed on Oct. 29, 2004.

(51) Int. Cl. B01D 53/22; B01D 61/42; B32B 9/00; B32B 19/00

(52) U.S. Cl. 428/701; 96/4; 96/7; 204/627; 428/702

(57) ABSTRACT

Supported thin film membranes of ceramic materials and electrochemical cells including supported thin film membranes. The microstructure of the support is particularly well suited for the well suited for subsequent infiltration with electrochemically active species (as solutions, slurries, or salts) to enhance chemical or electrical transport to the membrane and maintains satisfactory gas flow to the membrane after infiltration. This invention may be useful in electrochemical separations or catalytic reactors including, but not limited to, solid oxide fuel cells and oxygen separation membranes.

### CROSS-REFERENCE TO RELATED APPLICATIONS

Not applicable

### STATEMENT REGARDING FEDERALLY SPONSORED RESEARCH

Not applicable

### REFERENCE TO MICROFICHE APPENDIX

Not applicable

### FIELD OF THE INVENTION

This invention relates to supported thin film membranes of ceramic materials and electrochemical cells including supported thin film membranes. The support microstructure is particularly well suited for subsequent infiltration with electrochemically active species (as solutions, slurries, or salts) to enhance chemical or electrical transport to the membrane and provides satisfactory gas flow to the membrane after infiltration. This invention may be useful in electrochemical separations or catalytic reactors including, but not limited to, solid oxide fuel cells and oxygen separation membranes.

### BACKGROUND OF THE INVENTION

Ceramic membranes typically include a thin film membrane layer and a porous support layer that provides mechanical support and reactant transport to the membrane. The support may be active, meaning it provides electrical conductivity or contains catalytic materials, or passive, providing only mechanical support. These supported membranes may be prepared by many methods, including chemical and electrochemical vapor deposition, sol-gel coating, spray and dip coating particulate slurries, calendaring multilayer samples, and screen printing.

Perhaps the most widely used method for preparing supported membranes is tape casting, in which a porous-dense bi-layer is fabricated by the lamination of preceramic sheets containing the selected oxide powders, polymeric binders to provide plasticity to the tape, and a pyrolyzable fugitive phase in the support layer to prevent densification. The sheets typically are laminated at temperatures less than 100° C. to produce a monolithic body. The monolith is heated to ˜600° C. to remove the binder and fugitive phase, then fired to densify the membrane layer. Tape casting is material insensitive, and supported thin films of membrane material produced by tape casting have been deposited on cathodes, anodes, and inactive substrates.

When supported membranes are prepared by tape casting, the sintering cycle must be controlled to achieve the desired strength and interconnected porosity in the support structure while assuring the densification of the electrolyte. The sintering cycle also must be tailored to match the total shrinkage and the relative shrinkage rates of the two layers in the structure. A shrinkage mismatch between layers will cause the sample to warp during sintering, which must either be corrected by further heat treatment or allowed in the final reactor design.

In many electrochemical systems, dispersion of a catalytic phase in the microstructure of the support is desirable. The catalysts may perform a number of functions, including but not limited to the reformation of fuels, preferential oxidation of a feedstock, or electron transport for electrochemical reactions. The catalyst materials may be metallic species that are more expensive than the oxide support material, in which case it generally is preferable to minimize the content of the catalyst material in the oxide support material. Alternatively, the catalyst materials may be chemically or mechanically incompatible with the support and/or the membrane material at the cell fabrication temperature. In these cases, the catalytic species preferably is infiltrated into the support layer after the bi-layer is sintered at high temperature. For systems including a dispersed catalytic phase, the support structure must retain a high pore volume after heat treatment so that the catalyst can be deposited in the structure without closing pore channels. The porosity must be highly interconnected and sufficiently large in diameter to allow satisfactory gas transport after the catalyst infiltration. The support also must be strong enough to allow the handling and drying stresses associated with the infiltration processes.

Conventional processes for preparing supported membranes typically control the sinterability of the support and membrane layers by matching the particle size and surface area of the constituent powders. Fine oxide powders generally are selected to assure a fine grain size in the membrane layer and avoid pinhole formation. The fine oxide powders create a significant amount of fine scale porosity in the green body which may not be eliminated during sintering. The porosity may be modified by the addition of fugitives, which often have similar particle sizes to the powders. After sintering, the support structures produced from these mixtures have tortuous, fine scale pores that can easily be blocked by infiltrants. In addition, warping of the supported membrane must be managed by tight control of sintering conditions.

### SUMMARY OF THE INVENTION

The present invention provides a ceramic membrane in which the dense electrolyte layer is supported by a highly porous structure comprised of ceramic aggregates. This porous support provides particular advantages in providing gas flow to the membrane. It also is particularly well suited for the subsequent infiltration of electrochemically active species (as solutions, slurries, or salts) for the enhancement of chemical or electrical transport to the membrane.

The aggregate material used as the membrane support in the present invention is selected to sinter together well at temperatures below 1400° C. This allows the structure to achieve superior mechanical strength while preserving a large volume of highly accessible pores (i.e., interconnected pores with low tortuosity). The powder precursor of the support structure is calcined to reduce the surface area of the powder, eliminate fine scale porosity within the aggregates, and maintain sufficient surface energy in the aggregates to allow densification. The aggregate powders of the present invention do not close the large pore channels established during green forming. The open aggregate structure also limits shrinkage of the substrate during sintering (<20% linear shrinkage) and prevents warping the bi-layer. The resulting structures are mechanically robust and well-suited for subsequent infiltration

A preferred embodiment of the supported thin film ceramic membrane component comprises at least one sheet of a porous ceramic electrolyte material prepared from a powder precursor and at least one sheet of a dense ceramic electrolyte material positioned adjacent to the porous ceramic electrolyte material. The sheets are laminated and then sintered to form a composite structure. The powder precursor comprises an oxide material selected to sinter at a temperature below 1400° C., the oxide material being calcined to form 20-100 μm aggregates while retaining sinterability at temperatures below 1400° C.; a fugitive material in the amount of 0-70 volume percent; and binder. The supported thin film ceramic membrane component also may comprise an electrochemically active composition infiltrated into the more porous layer of the composite structure.

In a supported thin firm ceramic membrane component as described above, the porous ceramic electrolyte may be a partially stabilized zirconia composition. The dense ceramic electrolyte material may be a fully stabilized zirconia composition, preferably a yttria-stabilized zirconia. The fugitive material preferably has a particle size less than 200 microns.

### BRIEF DESCRIPTION OF THE DRAWINGS

These and further objects of the invention will become apparent from the following detailed description.

FIG. 1 is a schematic representation of the effect of fine fugitive materials on porosity development in thin film supported ceramic membranes.

FIG. 2 is a scanning electron micrograph (SEM) of the calcined partially stabilized zirconia powder of Example 1.

FIG. 3 is a depiction of the sintered bi-layer YSZ/PSZ laminate of Example 2.

FIG. 4 is an SEM image of a sintered bi-layer YSZ/PSZ laminate shown in FIG. 3.

FIG. 5 is an SEM image of the sintered bi-layer YSZ/PSZ laminate of Example 4.

FIG. 6 is an SEM image of the sintered bi-layer YSZ/PSZ laminate of Example 5.

FIG. 7 is an SEM image of the sintered bi-layer YSZ/PSZ laminate of Example 7.

### DETAILED DESCRIPTION OF CERTAIN PREFERRED EMBODIMENTS

The invention provides a dense ceramic membrane supported by a porous structure comprised of ceramic aggregates. The sintering temperature and the morphology of the powder precursor of the support structure are controlled to achieve the desired microstructure. The uniformity of aggregate size and size distribution and the sintering temperature of the aggregate are critical to achieving satisfactory results.

The aggregate material is selected to sinter together well at temperatures below 1400° C. The powder precursor is calcined to reduce the surface area of the powder, eliminate fine scale porosity within the aggregate, and maintain sufficient surface energy in the aggregates to allow densification while retaining sinterability at temperatures below 1400° C.

The calcined powder precursor yields a support having an open microstructure architecture, i.e., large interconnected pores with low tortuosity. The aggregate powders of the present invention cannot close the large pore channels established during green forming. The open structure of the aggregate material limits shrinkage during sintering (<20% linear shrinkage) to prevent warping the bi-layer, in contrast to conventional finer mixtures with fine pore structure, which tend to result in significant shrinkage. The resulting bi-layer structures are mechanically robust and well-suited for subsequent infiltration.

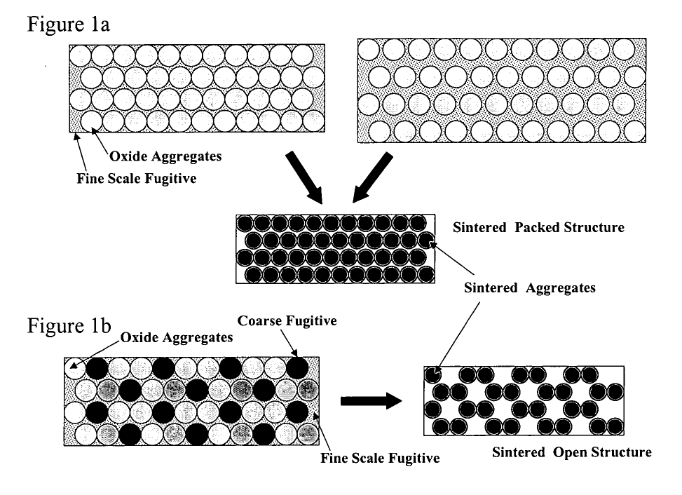

If necessary, the porosity of support architecture can be increased through the selection and addition of pore formers and fine scale fugitives, as described in the examples below. Alternately, the porosity of cell architecture can be increased by using very coarse particle size fugitive material, such that the diameter of the support powder and the fugitive material are of the same order of magnitude. As shown in FIG. 1, this approach may have significant advantages in the formation of porous substrates.

Section 1a of FIG. 1 is a schematic diagram illustrating the effect of fine fugitive materials (such as rice starch) on porosity development in the supported membranes of the present invention. Initial additions of pore formers fill the void space between oxide aggregates. As the amount of fugitive exceeds the volume of the void space, the aggregates are pushed apart until a continuum of fugitive material separates the particles. On heat treatment, the structure should collapse back to a level of packing similar to that achieved with lower fugitive content. However, if a fugitive material having a larger particle size is used, alone or in addition to a finer fugitive material, the oxide particle network should be displaced to create very large voids in the structure that will remain open after the binder is burned out, by virtue of the structural integrity of the interparticle network, as shown in Section 1b of FIG. 1. Sintering the structure should not cause it to collapse because the oxide particles are too large to move easily into the voids left by the fugitive material and shrinkage of the layer will be insufficient to develop stresses that would encourage rearrangement.

The oxide powder may be a stabilized zirconia composition, preferably a partially stabilized zirconia composition. The oxide powder precursor is tailored to achieve the desired microstructure by a calcination process that reduces the surface area of the powder, eliminates fine scale porosity within the aggregates, and maintains sufficient surface energy in the aggregates to allow densification. The oxide material is selected for good sinterability and is calcined under conditions that preserve this behavior. Preferably, the oxide powder precursor is calcined to form 20-100 μm aggregates. The

For example, the preceramic support structure may be fabricated using a spray dried, partially stabilized zirconia powder calcined to form 20-100 μm aggregates. The calcined PSZ powder may be incorporated into a tape slurry including a fugitive material and a binder, then cast into a tape having a desired thickness. Strips cut from the tape may be stacked to a desired number of layers.

The dense ceramic membrane of the present invention may, for example, be fabricated using a sub-micron fully stabilized zirconia composition including but not limited to YSZ. The YSZ powder may be incorporated into a tape casting slurry and cast into a tape having a desired thickness. Strips cut from the tape may be stacked to a desired number of layers.

The supported thin film membrane of the present invention include a desired number of strips of the dense ceramic membrane tape stacked on top of a desired number of strips of the porous support structure tape. For example, a two strips of the dense ceramic membrane tape may be placed on top of a five-layer stack of the porous support structure tape and the tape stack isostatically laminated to form a monolith. The laminate may be cut to shape and the shapes re-laminated if necessary to eliminate cutting defects along the edges. The bi-layer samples may then be heated to achieve binder burn-out and sintering. The sintered samples may be returned to the sintering furnace for forging to eliminate sample curvature, e.g., by flattening under 100 g load at elevated temperature.

After initial fabrication of the monolithic structure is complete, the porous support portion may be infiltrated with a suspension, solution or other wet precursor material to produce interpenetrating networks of electrolyte, electrode, and porosity. The substrate is then heat treated to remove solvent, organics or volatile groups and densify the residual solid component.

Specific examples of the preparation of the oxide powder precursor of the support layer and various bi-layer structures of the present invention are provided below. In these examples, the support powder was twenty to seventy microns in diameter; coarser powders, i.e., up to 100 microns in diameter, also may be used. The aggregates were selected to sinter together well at temperatures below 1400° C.

### EXAMPLE 1

### Oxide Powder Precursor of Support Layer

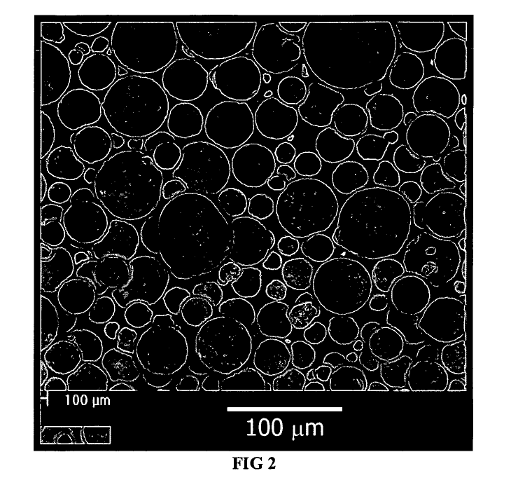

A partially stabilized zirconia (PSZ, Tosoh—TZ-3Y, initial SSA=14.7 m²/g) powder was calcined in 600 g batches at 1000° C. for 8 hours to modify the surface area and ruggedness of the aggregate structure. The calcined powder retained the morphology of the precursor powder, consisting of highly uniform spheres with an average diameter of 20-100 μm. The surface area (SSA) of the powder was measured to be 11.64 m²/g. The PSZ powder was sieved through a 100 mesh screen and then used to prepare tape casting slurries for the support layers. FIG. 2 shows an SEM of the as-calcined PSZ powder.

### EXAMPLE 2

### Bi-Layer Membrane, 40 vol. % Fugitive

The support tapes of PSZ were prepared using the PSZ powder of Example 1. The tape casting slurry was prepared in 500 ml Nalgene bottles. A bottle was filled with 300 g media (5 mm diameter, zirconia), 60.99 g solvent (Ferro, BD75-710), 0.86 g dispersant (Ferro, M1201), 19.05 g rice starch (Sigma), and 119.24 g PSZ powder. The bottle was sealed and shaken to mix the ingredients, then placed on a ball mill for 4 hours. After 4 hours of milling, the bottle was removed and 1.10 g di(propylene glycol) dibenzoate (Aldrich) and 49.86 g binder (Ferro, B7400) were added. The bottle was resealed and replaced on a slower ball mill for 12 hours. The milled slurry was decanted into a 250 ml Nalgene bottle and placed on a slow mill for one hour. The slurry was cast onto silicon-coated Mylar. The thickness of the dry tape was 150 μm. The tape was cut into 15×15 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on the mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 15×15 cm sheets. Two sheets of YSZ tape were placed on top of the 5-sheet stack of PSZ tape.

The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours.

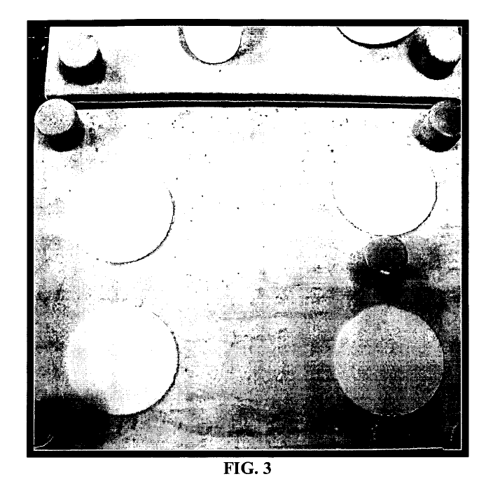

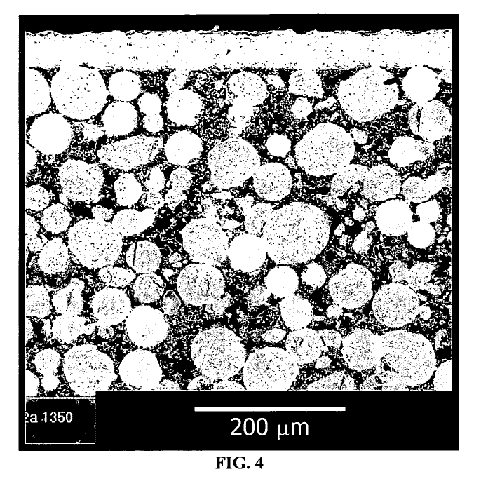

Examples of the sintered samples are shown in FIG. 3. The sintered samples were evaluated by SEM, as shown in FIG. 4. The cells had a support density of 3.59 g/cm3, approximately 60% of theoretical. The sintered samples were then flattened by placing about 100 g load on each sample and heating to 1300° C. for 6 hours.

### EXAMPLE 3

### Bi-Layer Membrane, 60 vol. % Fugitive

The support tapes of PSZ were prepared using the PSZ powder of Example 1. The tape casting slurry was prepared in 250 ml Nalgene bottles. A bottle was filled with 100 g media (5 mm diameter, zirconia), 27.75 g solvent (Ferro, BD75-710), 0.39 g dispersant (Ferro, M1201), 13.00 g rice starch (Sigma), and 36.17 g PSZ powder. The bottle was sealed and shaken to mix the ingredients, then placed on a ball mill for 4 hours. After 4 hour of milling, the bottle was removed and 0.50 g di(propylene glycol) dibenzoate (Aldrich) and 22.69 g binder (Ferro, B7400) were added. The bottle was resealed and replaced on a slower mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on a slower mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours. The sintered samples were then flattened by placing about 100 g load on each sample and heating to 1300° C.

### EXAMPLE 4

### Bi-Layer Membrane, 60 vol. % Fugitive with Extra Binder

The support tapes of PSZ were prepared using the PSZ powder of Example 1. The tape casting slurry was prepared in 250 ml Nalgene bottles. A bottle was filled with 100 g media (5 mm diameter, zirconia), 25.03 g solvent (Ferro, BD75-710), 0.39 g dispersant (Ferro, M1201), 13.00 g rice starch (Sigma), and 36.17 g PSZ powder. The bottle was sealed and shaken to mix the ingredients, then placed on a ball mill for 4 hours. After 4 hours of milling, the bottle was removed and 0.50 g di(propylene glycol) dibenzoate (Aldrich) and 25.41 g binder (Ferro, B7400) were added. The bottle was resealed and replaced on a slower ball mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on a slower ball mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours.

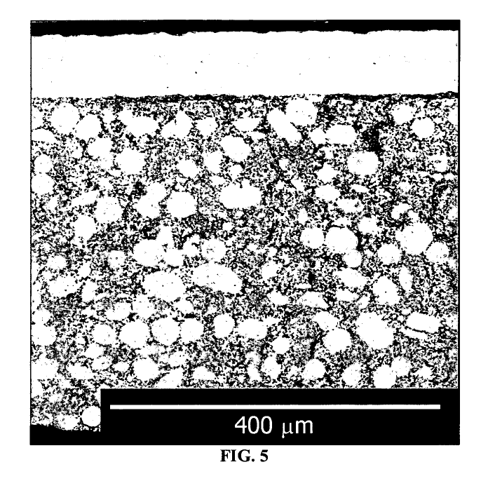

The sintered samples were evaluated by SEM, as shown in FIG. 5. The samples had a support density of 3.40 g/cm3, approximately 58% of theoretical. The sintered samples were then flattened by placing about 100 g load on each sample and heating to 1300° C. for 6 hours.

### EXAMPLE 5

### Bi-Layer Membrane, 65 vol. % Fugitive

The support tapes of PSZ were prepared using the PSZ powder of Example 1. The tape casting slurry was prepared in 250 ml Nalgene bottles. A bottle was filled with 100 g media (5 mm diameter, zirconia), 28.74 g solvent (Ferro, BD75-710), 0.40 g dispersant (Ferro, M1201), 14.59 g rice starch (Sigma-Aldrich), and 32.78 g PSZ powder. The bottle was sealed and shaken to mix the ingredients, then placed on a ball mill for 4 hours. After 4 hours of milling, the bottle was removed and 0.52 g di(propylene glycol) dibenzoate (Aldrich) and 23.49 g binder (Ferro, B7400) were added. The bottle was resealed and replaced on a slower ball mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on the a slower mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours.

The sintered samples were evaluated by SEM, as shown in FIG. 6. The samples had a support density of 2.81 g/cm3, approximately 47% of theoretical. The sintered samples were then flattened by placing about 100 g load on each sample and heating to 1300° C. for 6 hours.

### EXAMPLE 6

### Bi-Layer Membrane, 65 vol. % Fugitive with Extra Binder

The support tapes of PSZ were prepared using the PSZ powder of Example 1. The tape casting slurry was prepared in 250 ml Nalgene bottles. A bottle was filled with 100 g media (5 mm diameter, zirconia), 25.92 g solvent (Ferro, BD75-710), 0.40 g dispersant (Ferro, M1201), 14.59 g rice starch (Sigma-Aldrich), and 32.78 g PSZ powder. The bottle was sealed and shaken to mix the ingredients, then placed on a ball mill for 4 hours. After 4 hours of milling, the bottle was removed and 0.52 g di(propylene glycol) dibenzoate (Aldrich) and 26.31 g binder (Ferro, B7400) were added. The bottle was resealed and replaced on a slower ball mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on a slower ball mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours. The sintered samples were then flattened by placing about 100 g load on each sample and heating to 1300° C. for 6 hours.

### EXAMPLE 7

### Bi-Layer Membrane, 70 vol. % Fugitive

The support tapes of PSZ were prepared using the PSZ powder of Example 1. The tape casting slurry was prepared in 250 ml Nalgene bottles. A bottle was filled with 100 g media (5 mm diameter, zirconia), 29.80 g solvent (Ferro, BD75-710), 0.42 g dispersant (Ferro, M1201), 16.29 g rice starch (Sigma-Aldrich), and 29.13 g PSZ powder. The bottle was sealed and shaken to mix the ingredients, then placed on a ball mill for 4 hours. After 4 hours of milling, the bottle was removed and 0.54 g di(propylene glycol) dibenzoate (Aldrich) and 24.36 g binder (Ferro, B7400) were added. The bottle was resealed and replaced on a slower ball mill for 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on a slower ball mill for 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours.

The sintered samples were evaluated by SEM, as shown in FIG. 7. The samples had a support density of 2.89 g/cm3, approximately 49% of theoretical. The sintered samples were then flattened by placing about 100 g load on each sample and heating to 1300° C. for 6 hours.

### EXAMPLE 8

### Bi-Layer Membrane, 70 vol. % Fugitive with Extra Binder

The support tapes of PSZ were prepared using the PSZ powder of Example 1. The tape casting slurry was prepared in 250 ml Nalgene bottles. A bottle was filled with 100 g media (5 mm diameter, zirconia), 26.88 g solvent (Ferro, BD75-710), 0.42 g dispersant (Ferro, M1201), 16.29 g rice starch (Sigma-Aldrich), and 29.13 g PSZ powder. The bottle was sealed and shaken to mix the ingredients, then placed on a ball mill for 4 hours. After 4 hours of milling, the bottle was removed and 0.54 g di(propylene glycol) dibenzoate (Aldrich) and 27.28 g binder (Ferro, B7400) were added. The bottle was resealed and replaced on a slower ball mill 12 hours. The milled slurry was decanted into a 125 ml Nalgene bottle and placed on a slow mill for one hour. The slurry was cast onto silicon-coated Mylar. The thickness of the dry tape was 150 μm. The tape was cut into 7×7 cm sheets. The sheets were stacked on top each other, five sheets per stack, and set aside.

The membrane tapes of YSZ were prepared using as-received yttria-stabilized zirconia (YSZ, Tosoh—TZ-8Y, SSA=13.0 m²/g). The tape casting slurry was prepared in 500 ml Nalgene bottles. A bottle was filled with 300 g media (5 mm diameter, zirconia), 44.69 g solvent (Ferro, BD75-710), 0.38 g dispersant (Ferro, M1201), and 85.40 g YSZ powder. The bottle was sealed and shaken to mix the ingredients, then placed on a ball mill for 4 hours. After 4 hours of milling, the bottle was removed and 0.49 g di(propylene glycol) dibenzoate (Aldrich) and 19.53 g binder (Ferro, B7400) were added. The bottle was resealed and replaced on a slower ball mill 12 hours. The milled slurry was decanted into a 250 ml Nalgene bottle and placed on a slow mill for one hour. After de-airing, the slurry was cast onto silicon coated Mylar and allowed to dry for 2 hours. The thickness of the dry tape was 50 μm. The tape was cut into 7×7 cm sheets.

Two sheets of YSZ tape were placed on top of the 5-sheet stack of PSZ tape. The resulting YSZ/PSZ stack was laminated in an isostatic laminator at 80° C. and 96 MPa. The laminate was then cut into 3.2 cm diameter circles using a stainless steel punch. The circles were placed on porous setters (Seelee, Micromass) with the YSZ layers face down. The setters with the laminates were then placed in a furnace for binder burnout to 600° C. After the binder burnout, the samples were sintered at 1400° C. for 2 hours. The samples had a support density of 2.93 g/cm3, approximately 50% of theoretical. The sintered samples were then flattened by placing about 100 g load on each sample and heating to 1300° C. for 6 hours.

Sintered samples of the present invention were evaluated by SEM to determine the thicknesses of the dense membrane and the porous support. The density of the porous support was determined using the Archimedes method together with the results of SEM analysis.

As the above examples describe, the increase of fugitives and binder can be used to tailor the final porosity of the sintered samples. This type of microstructural control can be used to tailor shrinkage, pore volume, mechanical properties, and gas diffusion through the support layer. For example, though not demonstrated in the examples, the mechanical strength of the supports would be maximized by eliminating pore former from the tapes, reducing the pore volume and gas diffusion rates through the structure. However, there appears to be an upper limit to the utility of further organic additions in achieving extremely high pore volumes. It is expected that for fugitive content above 70 vol. %, the final porosity of the sintered parts will be near 50%. If the amount of fugitive is raised above 70 vol. %, the cell support is not likely to retain sufficient integrity to remain in a monolithic piece.

To convert the described bi-layer structures into electrochemical cells, electrodes are applied to each side of the membrane. Anodes may be selected from nickel-oxide/electrolyte composites, copper/electrolyte composites, and conductive oxides including but not limited to doped strontium titanate and lanthanum chromite. Cathodes may be selected from a doped rare-earth manganite, including but not limited to lanthanum strontium manganite, a doped rare-earth ferrite, including but not limited to lanthanum strontium ferrite, a doped-rare earth cobaltite including but not limited to lanthanum strontium cobaltite, a mixture thereof, and a solid solution thereof. For the bare membrane surface, any number of screen-printed, spray-coated or deposition approaches may be used to adhere the anodes to the cell surface. For the porous support side, solutions or salts precursors of the electrode materials (such as nickel nitrates, copper nitrate, organic salts of copper, nickel or other metals) may be deposited and calcined to crystallize the appropriate species. Organometallic and alkoxide precursors used in sol-gel processing may also be used to crystallize complex oxide cathodes and composite anode materials. Alternatively, fine powder suspensions, inks or other slurries of the desired anode and cathode phases may be infiltrated and sintered to form the composite structure.

The preferred embodiment of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention which is described by the following claims.

What is claimed is:

1. A supported thin film ceramic membrane component, comprising:
at least one sheet of a porous ceramic electrolyte material prepared from a powder precursor, the powder precursor comprising
an oxide material selected to sinter at a temperature below 1400° C., said oxide material being calcined to form 20-100 μm aggregates while retaining sinterability at temperatures below 1400° C.
a fugitive material in the amount of 0-70 volume percent; and
a binder;
at least one sheet of a dense ceramic electrolyte material positioned adjacent to the porous ceramic electrolyte material;
the sheets being laminated and then sintered to form a composite structure.

2. The supported ceramic membrane of claim 1, wherein the porous ceramic electrolyte material is a partially stabilized zirconia composition.

3. The supported ceramic membrane of claim 1, wherein the dense ceramic electrolyte material is a fully stabilized zirconia composition.

4. The supported ceramic membrane of claim 1, wherein the dense ceramic electrolyte material is yttria stabilized-zirconia.

5. The supported ceramic membrane of claim 1, wherein the porous ceramic electrolyte material is a partially stabilized zirconia composition and the dense ceramic electrolyte material is a fully stabilized-zirconia composition.

6. The supported ceramic membrane of claim 1, wherein the fugitive material has a particle size less than 200 microns.

7. The supported ceramic membrane of claim 1, further comprising:
an electrochemically active composition infiltrated into the more porous layer of the composite structure.
